(19) United States
(12) Patent Application Publication
(10) Pub. No.: US 2026/0131713 A1
(43) Pub. Date: May 14, 2026

(54) LEG REST MASSAGE DEVICE FOR VEHICLE SEAT

(71) Applicant: HYUNDAI TRANSYS INC., Seosan-si (KR)

(72) Inventors: Gu Chang KANG, Hwaseong-si (KR); Ui Jeong LEE, Hwaseong-si (KR); Hyun Seok SONG, Hwaseong-si (KR)

(21) Appl. No.: 19/032,368

(22) Filed: Jan. 20, 2025

(30) Foreign Application Priority Data
Feb. 2, 2024 (KR) 10-2024-0016816

(51) Int. Cl. B60N 2/90; A61H 15/00

(52) U.S. Cl. CPC B60N 2/976; A61H 15/0078; B60N 2/995; A61H 2015/0014; A61H 2201/1207; A61H 2205/106

(57) ABSTRACT

A leg rest massage device includes a bracket based on which the leg rest massage device is to be installed on a vehicle seat, a driving unit, the driving unit including a driving shaft and at least one or more motor carriers. The driving shaft is installed in a longitudinal direction of a bracket, and the motor carriers are arranged in a row on the driving shaft and are driven in opposite directions, and a moving unit coupled to the at least one or more motor carriers, the moving unit including a roller moved outwardly and inwardly in conjunction with driving of the motor carriers. The moving unit further includes gap adjustment members located with the bracket interposed therebetween, a gap between the gap adjustment members can be adjusted by rotation of the moving unit, and as the gap becomes small or large, the roller is moved outwardly or inwardly of the moving unit respectively so as to massage a calf of a passenger.

### CROSS-REFERENCE TO RELATED APPLICATION

This application claims, under 35 U.S.C. §119(a), the benefit of priority from Korean Patent Application No. 10-2024-0016816, filed on February 2, 2024, the entire contents of which are incorporated herein by reference.

### BACKGROUND

### a. Technical Field

The present disclosure relates to a leg rest massage device for a vehicle seat, and more particularly, to a massage device installed on a vehicle seat and configured to rub the calves of a passenger sitting on the vehicle seat, in which the massage device is configured to improve blood flow to the lower extremities and to prevent calf edema by providing direct pressure to the calves of the passenger.

### b. Background Art

When a passenger sits on a vehicle seat for a long time, the passenger feels uncomfortable due to the continued feeling of pressure on a body portion of the passenger, which is in close contact with the seat, leading to stiffness in the upper and lower body of the passenger, muscle pain, and the like. In order to solve the above-described problems, a seat massage device capable of massaging the passenger's body is installed in the seats of some luxury vehicles.

The seat massage device is mainly installed inside a seatback, which is in close contact with the back and waist of the passenger, and a seat cushion, which is in close contact with the hips and thighs of the passenger, among the plurality of seat components.

As an example of a seat massage device of the related art, a plurality of air cells is installed in the seatback and the seat cushion, thereby performing massage by expanding and contracting the air cells.

As another example of the seat massage device of the related art, a cylinder that is movable in the forward-and-rearward direction by driving of a motor is installed in the seatback and the seat cushion, thereby performing massage using striking force of the cylinder.

As described above, the seat massage device of the related art is mainly installed either in the seatback or in the seat cushion, or in both the seatback and the seat cushion forming the seat. In this manner, the massage may be easily performed on the upper body including the back and the waist of the passenger and the lower body including the hips and the thighs of the passenger.

However, since the seat massage device of the related art is mainly installed either in the seatback or in the seat cushion, or in both the seatback and the seat cushion forming the seat, there is a problem in that the calves of the passenger may not be massaged.

Accordingly, when the passenger sits on the vehicle seat for a long time, the passenger may feel uncomfortable because the flow of blood to the calves of the passenger is impeded, which may problematically increase passenger fatigue.

There is increasing demand for implementation of a massage function in a vehicle seat for passenger convenience, and various massage functions have been researched and developed to improve passenger comfort.

Currently, seat components or calf rests are applied to many vehicle models so as to provide an appropriate sitting posture for the passenger.

FIGS. 1A and 1B are a diagram showing a conventional seat leg rest.

As shown in FIGS. 1A and 1B, a seat leg rest includes a plate 11 that comes into contact with the calves of a passenger. The seat leg rest may support the calves of the passenger by lifting the plate 11 and may provide a comfortable posture for the passenger.

Meanwhile, although the conventional seat leg rest may provide a comfortable posture for the passenger by supporting the calves of the passenger, this seat leg rest may not directly reduce the fatigue of the passenger.

In addition, general leg rests have been developed in many industries other than the vehicle seat industry. For example, there is a leg rest configured to wrap the calves of the passenger using an air bladder and to apply pressure to the air bladder so as to massage the calves.

However, it is difficult to apply these general leg rests to a vehicle seat. For example, since the conventional leg rest is installed on the vehicle seat, the passenger has limited space to use, and it is difficult to effectively implement the function of the vehicle package space. In addition, when the above-mentioned conventional structure that wraps the passenger's legs with the air bladder is applied to the vehicle seat, the structure may cause inconvenience to the passenger when the passenger enters and exits the vehicle. Further, the conventional structure may cause hinderance when the passenger escapes from the vehicle in the event of vehicle collision, emergency, and the like. In consideration of the above-described problems, it is difficult to install the conventional leg rest device in the vehicle.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an object of the present disclosure to provide a leg rest massage device capable of being installed in a vehicle.

Another object of the present disclosure is to provide a massage device capable of being installed in a vehicle without spatial constraints and utilizing the vehicle space.

Still another object of the present disclosure is to provide a massage device capable of massaging the passenger's legs in a state of wrapping the legs. Accordingly, even if the massage device is installed in a vehicle, the passenger may safely escape from the vehicle in the event of emergency.

The objects of the present disclosure are not limited to the above-mentioned objects, and other technical objects not mentioned herein will be clearly understood by those skilled in the art to which the present disclosure pertains from the detailed description of the embodiments. Additionally, the objects of the present disclosure may be achieved by means and combinations thereof as indicated in the claims.

In one aspect, the present disclosure provides a leg rest massage device including a bracket based on which the leg rest massage device is configured to be installed on a vehicle seat, a driving unit, the driving unit including a driving shaft and at least one or more motor carriers, wherein the driving shaft is installed in a longitudinal direction of the bracket, and the motor carriers are arranged in a row on the driving shaft and are driven in opposite directions, and a moving unit coupled to the at least one or more motor carriers, the moving unit including a roller configured to be moved outwardly and inwardly of the moving unit in conjunction with driving of the motor carriers, wherein the moving unit further includes gap adjustment members respectively located on opposite sides of the bracket with the bracket interposed therebetween, a gap between the gap adjustment members is adjusted by rotation of the moving unit.

In an example embodiment, as the gap between the gap adjustment members becomes small or large, the roller is configured to be moved outwardly or inwardly of the moving unit respectively so as to massage a calf of a passenger.

In an example embodiment, the driving unit may include a driving motor driven by an electrical signal, the driving shaft connected to the driving motor, and the motor carriers are configured to be moved in a direction away from each other or toward each other.

In another example embodiment, the moving unit may further include a roller wire connected to the roller and configured to accommodate the calf of the passenger thereon, link brackets each including a first end coupled to a corresponding one of the motor carriers and a second end coupled to a corresponding one of the gap adjustment members, the link brackets configured to be rotated by the driving of the motor carriers, plate springs respectively located adjacent to the gap adjustment members, the roller configured to rub the calf of the passenger, the gap adjustment members respectively installed on the opposite sides of the bracket, and each of the plate springs being deformed into a convex or flat shape as the gap between the gap adjustment members is adjusted.

In still another example embodiment, at least one or more of the plate springs of the moving unit may be arranged perpendicularly across the bracket and at predetermined intervals along the bracket, and the moving unit may further include a rail part having a continuous groove formed therein and configured for the plate springs to be inserted thereinto.

In yet another example embodiment, the leg rest massage device may further include main wires each configured to respectively penetrate a corresponding one of the gap adjustment members, wherein each of the main wires may serve to guide movement of the corresponding one of the gap adjustment members.

In still yet another example embodiment, a force applied to the calf of the passenger may be determined by an area covered by the roller of the moving unit during rotation, and a process of releasing the applied force may be repeatedly performed to provide a massage function.

In a further example embodiment, the link brackets may connect the motor carriers to each other and may be configured to be rotated clockwise or counterclockwise so as to pull or push the motor carriers.

In another further example embodiment, the at least one or more motor carriers may be mounted on the bracket and may be slidably movable in the longitudinal direction of the bracket.

In still another further example embodiment, a massage speed applied to the calf of the passenger may be determined by a movement speed of each of the motor carriers.

In still yet another further example embodiment, the leg rest massage device may further include a case configured to accommodate the driving unit, the moving unit, the main wires, and the bracket.

In a still further example embodiment, the leg rest massage device may further include a sheet covering the case.

In a yet still further example embodiment, the case may be directly coupled to the seat and may be rotatably movable by 90 degrees when used by the passenger.

Other aspects and example embodiments of the disclosure are discussed infra.

It is understood that the terms "vehicle", "vehicular", and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1A and 1B are a diagram showing a conventional leg rest for a vehicle seat;

FIG. 2 is a diagram showing a leg rest massage device for a vehicle seat according to the present disclosure;

FIG. 3 is a diagram showing a state in which the leg rest massage device for a vehicle seat according to the present disclosure is not driven;

FIG. 4 is a diagram showing a state in which the leg rest massage device for a vehicle seat according to the present disclosure is driven;

FIG. 5A is a diagram showing a state in which the leg rest massage device for a vehicle seat according to the present disclosure is not driven;

FIG. 5B is a diagram showing a state in which the leg rest massage device for a vehicle seat according to the present disclosure is driven;

FIG. 6 is a diagram showing the leg rest massage device for a vehicle seat according to the present disclosure;

FIG. 7 is a cross-sectional view taken along line A-A' in FIG. 6;

FIG. 8 is a diagram showing a state in which the leg rest massage device for a vehicle seat according to the present disclosure is driven; and

FIG. 9 is a cross-sectional view taken along line B-B' in FIG. 8.

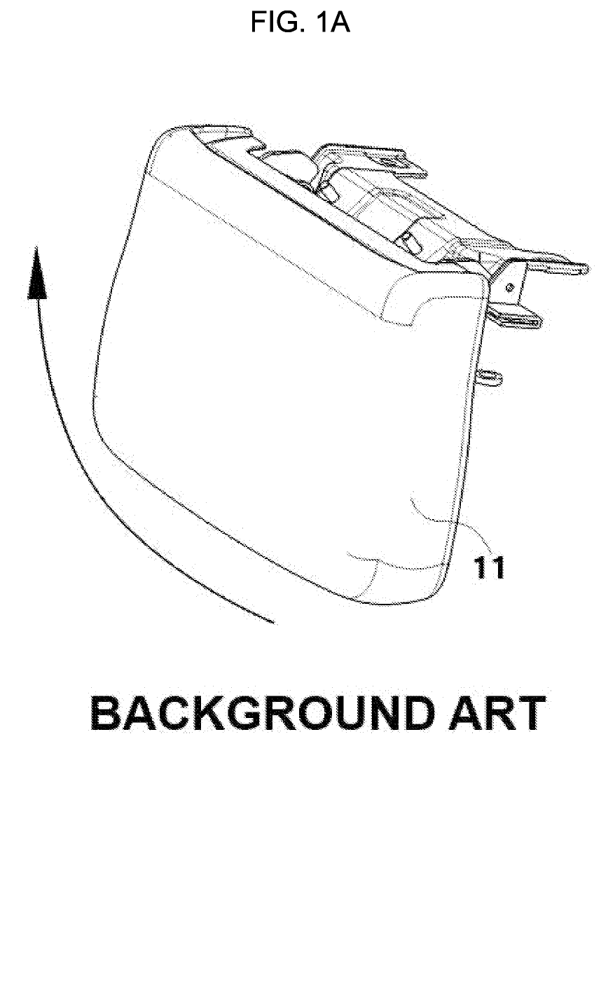

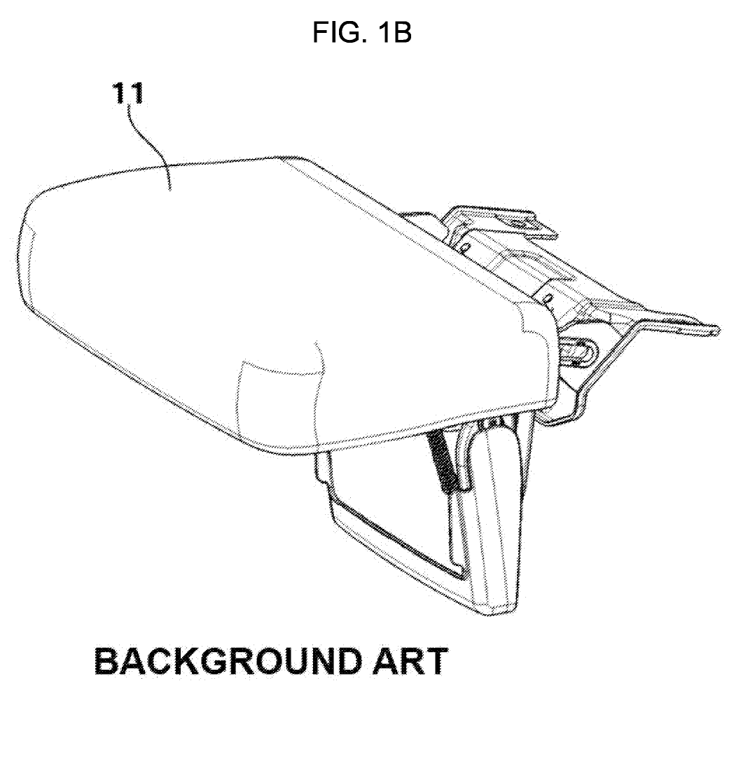

It should be understood that the appended drawings are not necessarily to scale, presenting a somewhat simplified representation of various example features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various embodiments of the present disclosure, examples of which are illustrated in the accompanying drawings and described below. While the disclosure will be described in conjunction with exemplary embodiments, it will be understood that the present description is not intended to limit the disclosure to the exemplary embodiments. On the contrary, the disclosure is intended to cover not only the exemplary embodiments, but also various alternatives, modifications, equivalents, and other embodiments, which may be included within the spirit and scope of the disclosure as defined by the appended claims. The present embodiments are provided to more fully explain the disclosure to those of ordinary knowledge in the art.

Terms such as "part", "unit", and "module" described in the specification mean a unit configured to process at least two functions or operations, and the unit may be implemented by hardware or software or a combination of hardware and software.

The terms used in the specification are merely used to describe specific embodiments and are not intended to limit the embodiments. Singular forms are intended to include plural forms as well, unless the context clearly indicates otherwise.

Meanwhile, in this specification, terms such as "first" and "second" are used to describe various components having the same names, and the terms are used only for the purpose of distinguishing one component from other components. The components are not limited by the terms in the following description.

Hereinafter, embodiments will be described in detail with reference to the accompanying drawings. In describing the embodiments with reference to the accompanying drawings, the same or corresponding components will be denoted by the same reference numerals and redundant description thereof will be omitted.

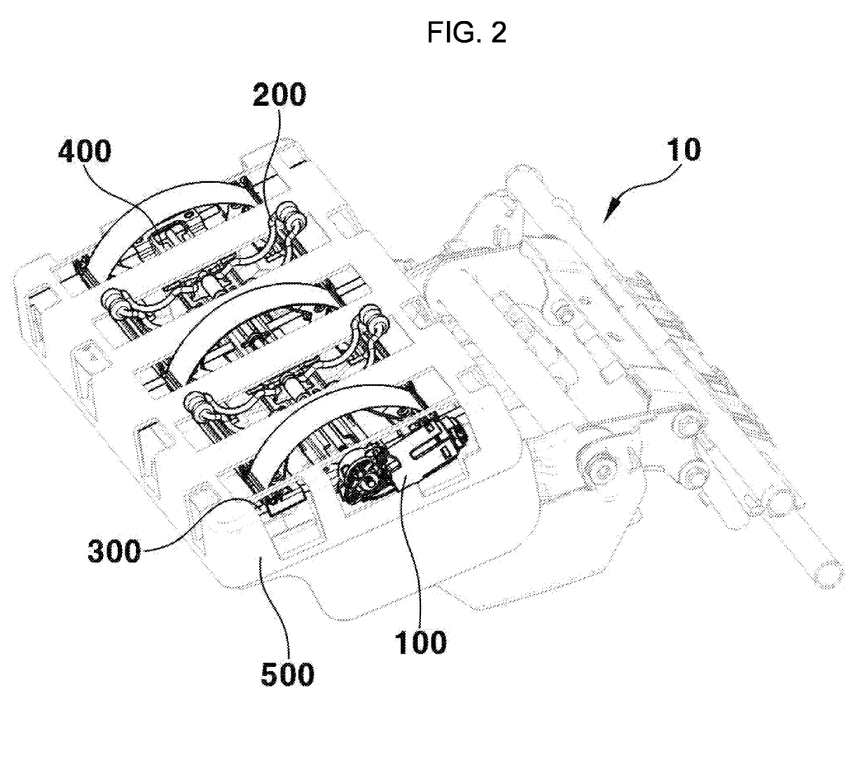

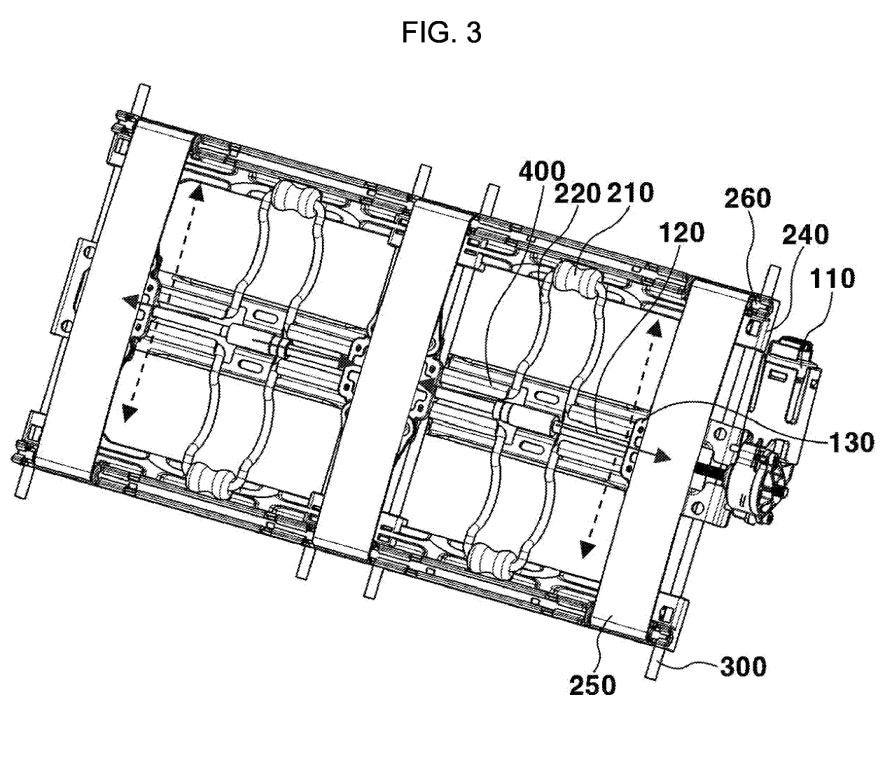

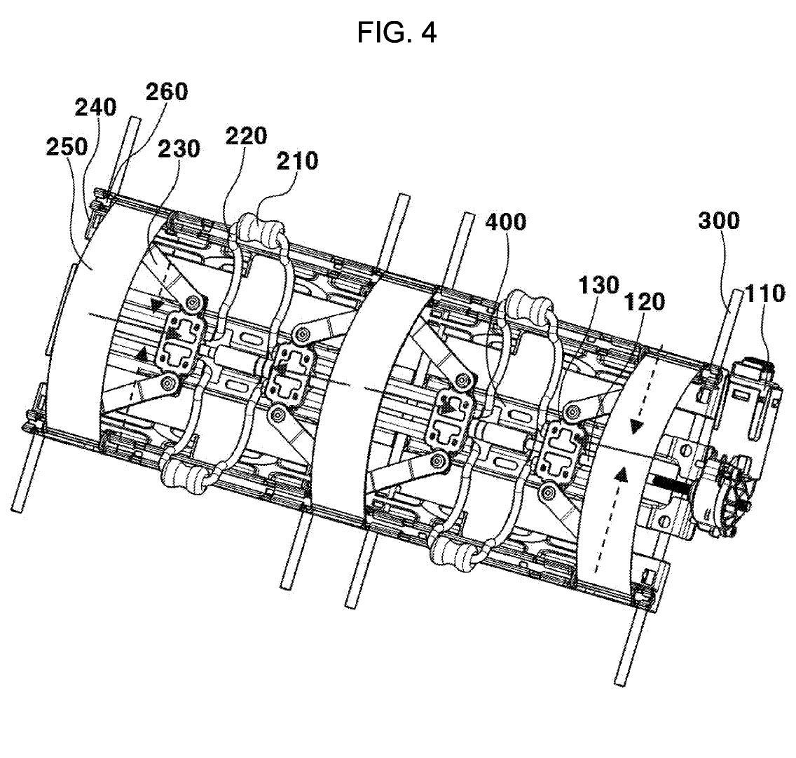

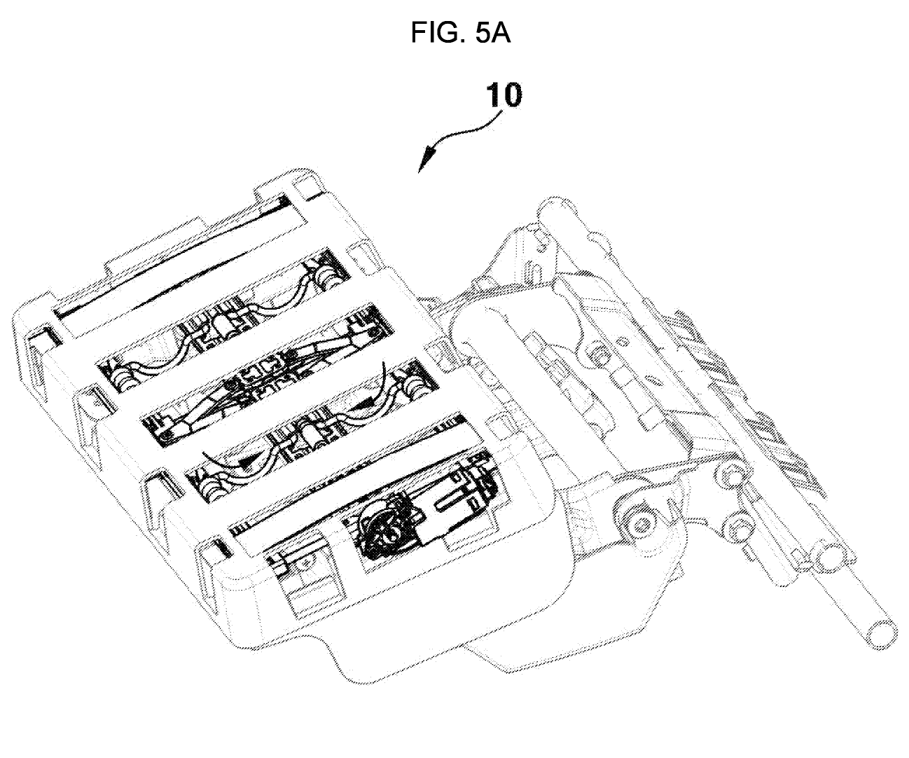

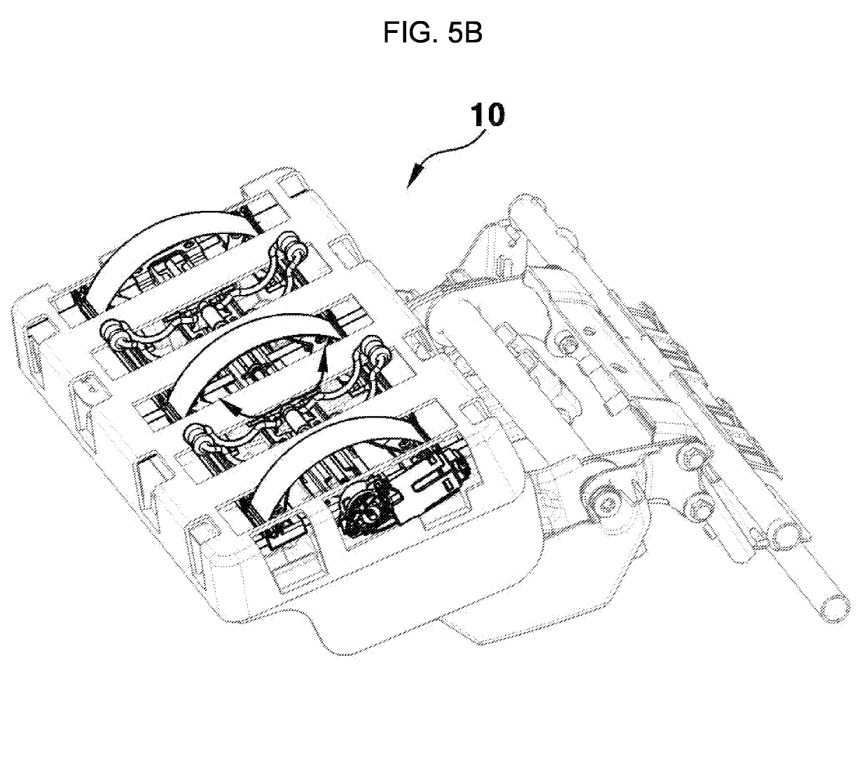

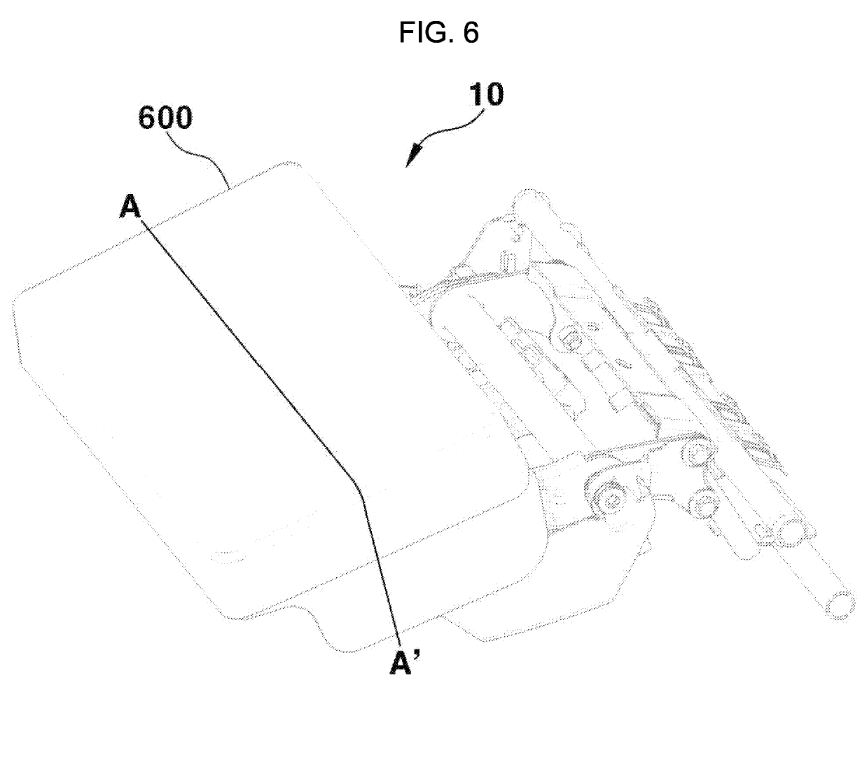

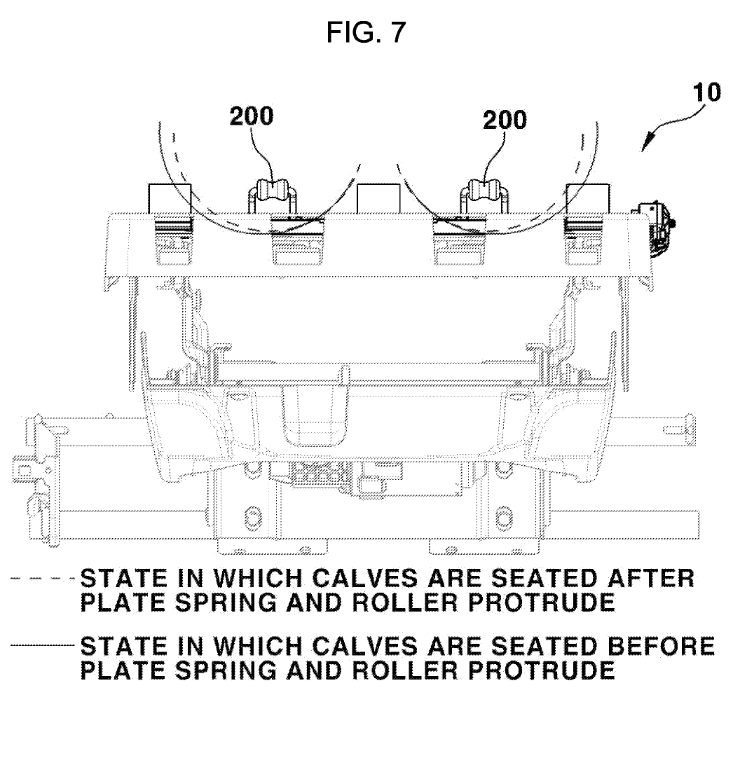

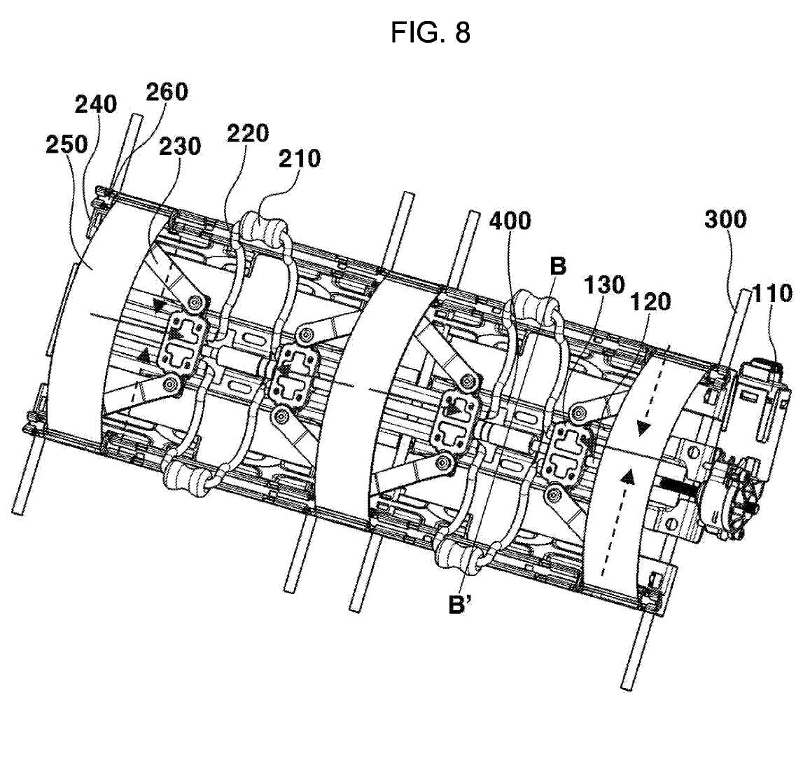

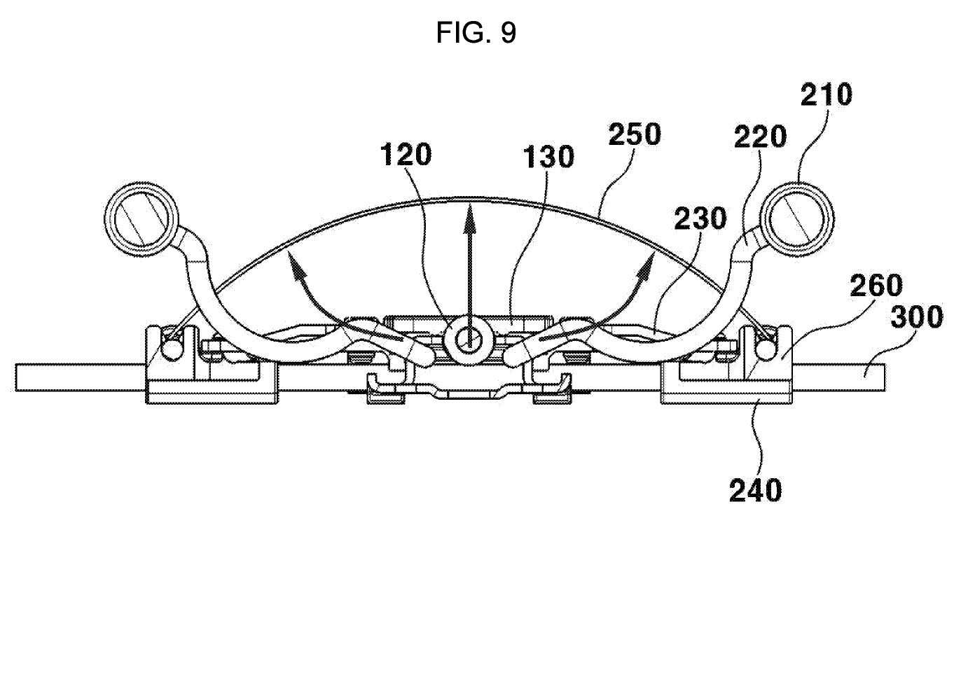

FIG. 2 is a diagram showing a leg rest massage device for a vehicle seat according to the present disclosure, FIG. 3 is a diagram showing a state in which the leg rest massage device for a vehicle seat according to the present disclosure is not driven, FIG. 4 is a diagram showing a state in which the leg rest massage device for a vehicle seat according to the present disclosure is driven, FIG. 5A is a diagram showing a state in which the leg rest massage device for a vehicle seat according to the present disclosure is not driven, FIG. 5B is a diagram showing a state in which the leg rest massage device for a vehicle seat according to the present disclosure is driven, FIG. 6 is a diagram showing the leg rest massage device for a vehicle seat according to the present disclosure, FIG. 7 is a cross-sectional view taken along line A-A' in FIG. 6, FIG. 8 is a diagram showing a state in which the leg rest massage device for a vehicle seat according to the present disclosure is driven, and FIG. 9 is a cross-sectional view taken along line B-B' in FIG. 8.

First, as shown in FIG. 2, a leg rest massage device 10 for a vehicle seat according to an embodiment of the present disclosure is provided to massage the calves of the passenger and is formed of a driving unit 100, a moving unit 200, and a main wire 300. The leg rest massage device 10 may further include a bracket 400 configured to install the driving unit 100, the moving unit 200, and the main wire 300 on the vehicle seat, and a case 500 configured to accommodate the driving unit 100, the moving unit 200, and the bracket 400 therein. In addition, as shown in FIG. 6, the leg rest massage device 10 may further include a sheet 600 that covers the case 500.

Meanwhile, depending on implementation of the leg rest massage device 10, the passenger may directly attach the leg rest massage device 10 to the seat and use the same, as necessary.

First, the case 500 of the leg rest massage device 10 is coupled to the seat on which the passenger sits and is configured to be rotatably movable by 90 degrees so as to support the calves of the passenger. Specifically, the case 500 of the leg rest massage device 10 of the present disclosure is configured to be coupled to the seat, to receive an electrical signal from a remote control (not shown) or a control module (not shown), and to be vertically rotated on the seat in response to the electrical signal.

Here, the remote control or the control module may further include a controller installed therein and configured to enable a user to designate a massage time or a massage pattern and to adjust pressing force and a pressing force cycle of the leg rest massage device 10. Meanwhile, the remote control or the control module of the present disclosure may further include an angle adjustment module installed therein and configured to adjust the rotation angle of the case 500 coupled to the seat. Here, since vehicle collision may occur while the leg rest massage device 10 is operated, the remote control or the control module may further include a blocking module installed therein and configured to quickly cut off the power in the event of emergency.

Meanwhile, the sheet 600 of the leg rest massage device 10 of the present disclosure is a portion that comes into contact with the legs of the passenger. The sheet 600 of the massage device may be made of any one of cloth, leather, and sponge, and may be made of a highly elastic material.

Referring to FIGS. 3 and 4, the driving unit 100 of the leg rest massage device 10 according to the embodiment of the present disclosure is built into the vehicle seat and includes a driving motor 110, a driving shaft 120, and a motor carrier 130.

The driving motor 110 of the driving unit 100 of the leg rest massage device 10 according to the embodiment of the present disclosure is mounted in the case 500. Here, the driving motor 110 is driven by an electrical signal of a remote control or a control module, converts rotational motion into linear reciprocating motion, and drives at least one or more motor carriers 130 installed on the driving shaft 120 in a direction away from each other or toward each other.

The driving shaft 120 of the driving unit 100 is mounted in the longitudinal direction of the bracket 400. One end of the driving shaft 120 is connected to the driving motor 110, and the other end thereof is fixed to the bracket 400 using a holder. In addition, the driving shaft 120 may be formed in the shape of a rod having a predetermined diameter. However, depending on implementation of the driving shaft 120, the driving shaft 120 may be formed in the shape of a rectangular parallelepiped rod, and any shape may be adopted as long as the motor carrier 130 is slidably movable along the driving shaft 120.

At least one or more motor carriers 130 of the driving unit 100 are arranged in a row on the driving shaft 120, and the carriers 130 are slidably moved in opposite directions. Specifically, the motor carriers 130 of the driving unit 100 are fitted to the driving shaft 120 and are slidably movable left and right in the longitudinal direction of the bracket 400. At least one or more motor carriers 130 installed on the driving shaft 120 are moved in any one of the left and right directions. For example, when the motor carrier 130 located closest to the driving motor 110 is moved to the right in the left and right directions, the other motor carrier 130 located closest to the above-mentioned motor carrier 130 among the motor carriers 130 arranged in a row is moved to the left. As shown in FIG. 4, the motor carriers 130 are arranged to be movable in any one of the left and right directions, respectively.

The moving units 200 of the leg rest massage device 10 according to the embodiment of the present disclosure are respectively coupled with the motor carriers 130 and perform rotational motion when the respective motor carriers 130 are driven.

First, the moving unit 200 of the present disclosure is formed of a roller 210, a roller wire 220, a link bracket 230, a gap adjustment member 240, a plate spring 250, and a rail part 260.

The roller 210 of the moving unit 200 of the present disclosure performs the role of compressing and relaxing the calves of the passenger through repeated upward movement and downward movement thereof. In addition, a central hole is formed in the center of the roller 210, and the roller wire 220 is inserted into the central hole.

The roller wire 220 of the moving unit 200 of the present disclosure is coupled to the roller 210, and the calf of the passenger is placed on the roller wire. Specifically, the roller wire 220 of the moving unit 200 may be provided to allow the calf portion to be placed thereon. Here, an area of the roller wire on which the calf is seated may be moved outwardly and inwardly of the moving unit 200. The shape of the roller wire 220 may prevent the calf of the passenger from being pushed outwards, and the area on which the calf is seated may be formed as an empty space so as to allow the calf to be stably seated thereon. The roller wire 220 is formed to have a concave shape such that the roller 210 is movable outwardly and inwardly of the moving unit 200 through interference between the gap adjustment member 240 and the roller wire 220 according to movement of the gap adjustment member 240.

The link bracket 230 of the moving unit 200 of the present disclosure has a first end coupled to the gap adjustment member 240 to be described later and a second end coupled to the motor carrier 130. In this manner, the link bracket is rotated clockwise or counterclockwise by driving of the motor carrier 130. Specifically, at least one or more link brackets 230 of the moving unit 200 are provided. Here, one motor carrier 130 may be coupled to four link brackets 230. At least two link brackets 230 may be coupled to the motor carrier in a direction in which the motor carrier 130 is moved, and two link brackets 230 may be coupled thereto in order to push and pull the motor carrier 130 with the same force in both directions. It is also possible for three or more link brackets 230 to be coupled to the motor carrier 130.

Meanwhile, the first end of the link bracket 230 is coupled to the motor carrier 130, and the second end thereof is coupled to the gap adjustment member 240. Here, when the motor carrier 130 of the present disclosure is not driven, the link bracket 230 coupled to the gap adjustment member 240 and the motor carrier 130 may be positioned horizontally. Conversely, when the motor carrier 130 is driven, the link bracket 230 is rotated clockwise or counterclockwise while forming a predetermined angle.

Next, the gap adjustment members 240 of the moving unit 200 of the present disclosure are respectively located on opposite sides of the bracket 400 with the bracket 400 interposed therebetween. In addition, each of the gap adjustment members 240 of the moving unit 200 of the present disclosure is located to support the roller wire 220 and is moved in the left and right direction with respect to the bracket 400 so as to move the roller wire 220 outwardly and inwardly. For example, as a gap between the gap adjustment members 240 respectively located on the opposite sides of the bracket 400 with the bracket 400 interposed therebetween becomes small, the roller wire 220 is moved outwardly of the moving unit 200, and as the gap between the gap adjustment members 240 becomes large, the roller wire 220 is moved inwardly of the moving unit 200. Specific driving of upward movement and downward movement of the roller wire 220 through interference between the gap adjustment members 240 and the roller wire 220 will be described with reference to FIGS. 6 to 9.

The plate spring 250 of the moving unit 200 of the present disclosure is located by being fitted into the rail part 260 to be described later. The plate spring 250 is made of an elastic material such that, as the gap between the gap adjustment members 240 becomes small, the plate spring 250 is located convexly in the forward direction, and as the gap between the gap adjustment members 240 becomes large, the plate spring 250 is located horizontally. In addition, the plate spring 250 of the moving unit 200 plays a role in holding the calves of the passenger, and at least one or more plate springs 250 are arranged across the bracket 400 and at predetermined intervals therebetween along the bracket 400 so as to allow the calves to be stably seated thereon.

Next, the rail part 260 of the moving unit 200 of the present disclosure is located above the gap adjustment member 240 and has a groove formed therein and configured for the plate spring 250 to be inserted thereinto. In addition, the rail part 260 is coupled to the gap adjustment member 240. Accordingly, as the gap adjustment member 240 is moved outwardly or inwardly of the moving unit 200, the rail part 260 is also moved in an outward or inward direction respectively. Additionally, one side of the rail part 260 is penetrated such that the main wire 300 is inserted into and located in the one side, and the rail part 260 is stably moved by the main wire 300 penetrating the one side of the rail part 260.

In this manner, the rail part 260 and the gap adjustment member 240 of the present disclosure are coupled to each other and are integrally moved in the upward-and-downward direction. Here, the gap adjustment member 240 raises and lowers the roller wire 220, and the rail part 260 is coupled to the plate spring 250 so as to maintain the plate spring in the convex state or flat state, thereby stably holding the calves of the passenger and massaging the calves.

At least one or more main wires 300 of the leg rest massage device 10 according to the embodiment of the present disclosure are arranged across he bracket 400 spaced apart from each other and are respectively coupled to the gap adjustment member 240 and the rail part 260 by passing therethrough, thereby serving to guide the gap adjustment member 240 and the rail part 260 so as to enable the gap adjustment member 240 and the rail part 260 to be constantly moved in the upward-and-downward direction.

The bracket 400 of the leg rest massage device 10 according to the embodiment of the present disclosure is configured to be stably coupled to the case 500. Hereinafter, a detailed description will be given as to driving of the leg rest massage device 10 of the present disclosure.

FIG. 5A is a diagram showing a state in which the leg rest massage device for a vehicle seat according to the present disclosure is not driven, FIG. 5B is a diagram showing a state in which the leg rest massage device for a vehicle seat according to the present disclosure is driven, FIG. 6 is a diagram showing the leg rest massage device for a vehicle seat according to the present disclosure, FIG. 7 is a cross-sectional view taken along line A-A' in FIG. 6, FIG. 8 is a diagram showing a state in which the leg rest massage device for a vehicle seat according to the present disclosure is driven, and FIG. 9 is a cross-sectional view taken along line B-B' in FIG. 8.

Referring to FIGS. 5 to 9, the leg rest massage device 10 may be configured in such a manner that, when a passenger operates a remote control or a control module to drive the massage device 10, the massage device protrudes convexly from the seat so as to perform a massage operation of compressing and relaxing the calves of the passenger, and when the passenger does not use the massage device 10, the massage device 10 is placed inside the case 500.

Specifically, the leg rest massage device 10 first prepares to massage the calves of the passenger. When driving of the leg rest massage device 10 is started, the roller wires 220 protrude from the seat and start massaging the calves. At least one or more motor carriers 130 connected to the driving motor 110 are spaced apart from each other and start movement thereof in the left and right directions. The link brackets 230 respectively connected to the motor carriers 130 start to be rotated clockwise or counterclockwise. In addition, a gap between the gap adjustment members 240 respectively connected to the link brackets 230 is controlled to repeatedly become small and large.

When the gap between the gap adjustment members 240 is small, the roller wires 220 respectively seated on the gap adjustment members 240 are moved outwardly of the moving unit 200, and when the gap between the gap adjustment members 240 is large, the roller wires 220 are moved inwardly of the moving unit 200.

In this manner, the calves of the passenger seated on the roller wires 220 are massaged through upward movement and downward movement of the rollers 210.

Specifically, referring to FIGS. 6 and 7, before the leg rest massage device 10 is driven, the plate springs 250 and the rollers 210 serve to hold the calves of the passenger, but when driving of the leg rest massage device 10 is started, the plate springs 250 and the rollers 210 protrude and start massaging the calves. Specifically, it may be seen that the radius of the curved shape before the leg rest massage device 10 is driven is smaller than that after the leg rest massage device 10 is driven.

Specifically, referring to FIGS. 8 and 9, the calves are seated in the direction of the bracket 400 of the leg rest massage device 10, the motor carriers 130 of the driving unit 100 are moved in the longitudinal direction of the bracket 400 in response to a driving signal, and the link brackets 230 respectively coupled to the motor carriers 130 perform rotational motion. In this case, the gap adjustment members 240 respectively coupled to the link brackets 230 are moved in a direction approaching each other or are moved in a direction away from each other, thereby performing upward movement and downward movement of the roller wires 220. Through repetition of this operation, it is possible to perform a massage function of compressing and relaxing the calves.

In this manner, through the rollers 210 respectively coupled to the roller wires 220, it is possible to achieve an effect of improving blood flow to the lower extremities of the passenger and preventing calf edema through repetition of compressing and relaxing the calves of the passenger. In addition, depending on implementation of the leg rest massage device 10 of the present disclosure, it is possible to appropriately adjust, in response to a driving signal input by the passenger, the driving time of the leg rest massage device so as to compress and relax the calves longer or shorter.

In addition, the leg rest massage device 10 of the present disclosure is configured to be coupled to the vehicle seat and installed inside the case 500. Accordingly, the leg rest massage device 10 may be installed in the vehicle without spatial constraints. Further, since the leg rest massage device 10 has a compact size and light weight, manufacturing costs may be reduced. Additionally, since the leg rest massage device 10 has a simple structure, a manufacturing process thereof may be simple, and production efficiency may be improved.

Additionally, the leg rest massage device 10 has a function of directly massaging the calves of the passenger, thereby improving blood flow to the lower extremities of the passenger and preventing calf edema.

Finally, since the leg rest massage device 10 is accommodated in the seat when not in use, the passenger easily enters and exits the vehicle without interference with the leg rest massage device.

As is apparent from the above description, the present disclosure may achieve the following effects by the configuration, combination, and use relationship described in the embodiments.

The present disclosure provides a leg rest massage device capable of being installed in a vehicle. Further, the leg rest massage device may be installed in the vehicle without spatial constraints and may utilize the vehicle space.

Furthermore, the leg rest massage device is capable of massaging the passenger's legs in a state of wrapping the legs. Accordingly, even if the leg rest massage device is installed in the vehicle, the passenger may safely escape from the vehicle in the event of emergency.

The present disclosure has been described in detail with reference to example embodiments thereof, and the present disclosure may be used in various other combinations, modifications, and environments. That is, it will be appreciated by those skilled in the art that changes may be made in these embodiments without departing from the principles and spirit of the disclosure, the scope of which is defined in the appended claims and equivalents thereto. The embodiments describe the best mode to implement the technical idea of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

What is claimed is:

1. A leg rest massage device comprising:
a bracket based on which the leg rest massage device is to be installed on a vehicle seat;
a driving unit comprising a driving shaft and at least one or more motor carriers, wherein the driving shaft is installed in a longitudinal direction of the bracket, and the motor carriers are arranged in a row on the driving shaft and are driven in opposite directions; and
a moving unit coupled to the at least one or more motor carriers, the moving unit comprising a roller configured to be moved outwardly and inwardly of the moving unit in conjunction with driving of the motor carriers, the moving unit further comprising gap adjustment members respectively located on opposite sides of the bracket with the bracket interposed therebetween, a gap between the gap adjustment members configured to be adjusted by rotation of the moving unit.

2. The leg rest massage device of claim 1, wherein, as the gap between the gap adjustment members becomes small or large, the roller is configured to be moved outwardly or inwardly of the moving unit respectively so as to massage a calf of a passenger.

3. The leg rest massage device of claim 1, wherein the driving unit comprises:
a driving motor configured to be driven by an electrical signal, and
wherein the driving shaft is connected to the driving motor; and
the motor carriers are configured to be moved in a direction away from each other or toward each other.

4. The leg rest massage device of claim 1, wherein the moving unit further comprises:
a roller wire connected to the roller and configured to accommodate the calf of the passenger thereon;
link brackets each including a first end coupled to a corresponding one of the motor carriers and a second end coupled to a corresponding one of the gap adjustment members, the link brackets configured to be rotated by the driving of the motor carriers; and
plate springs respectively located adjacent to the gap adjustment members,
wherein the roller is configured to rub the calf of the passenger;
wherein the gap adjustment members are respectively installed on the opposite sides of the bracket; and
wherein each of the plate springs are configured to be deformed into a convex or flat shape as the gap between the gap adjustment members is adjusted.

5. The leg rest massage device of claim 4, wherein:
at least one or more of the plate springs of the moving unit are arranged perpendicularly across the bracket and at predetermined intervals along the bracket, and
the moving unit further comprises a rail part including a continuous groove formed therein and configured for the plate springs to be inserted thereinto.

6. The leg rest massage device of claim 1, further comprising main wires each configured to respectively penetrate a corresponding one of the gap adjustment members,
wherein each of the main wires serves to guide movement of the corresponding one of the gap adjustment members.

7. The leg rest massage device of claim 1, wherein a force applied to the calf of the passenger is determined by an area covered by the roller of the moving unit during rotation, and a process of releasing the applied force is repeatedly performed to provide a massage function.

8. The leg rest massage device of claim 4, wherein the link brackets connect the motor carriers to each other and are configured to be rotated clockwise or counterclockwise so as to pull or push the motor carriers.

9. The leg rest massage device of claim 1, wherein the at least one or more motor carriers are mounted on the bracket and are slidably movable in the longitudinal direction of the bracket.

10. The leg rest massage device of claim 1, wherein a massage speed applied to the calf of the passenger is determined by a movement speed of each of the motor carriers.

11. The leg rest massage device of claim 5, further comprising a case configured to accommodate the driving unit, the moving unit, the main wires, and the bracket.

12. The leg rest massage device of claim 11, further comprising a sheet covering the case.

13. The leg rest massage device of claim 11, wherein the case is directly coupled to the seat and is rotatably movable by 90 degrees when used by the passenger.
